(19) United States
(12) Patent Application Publication
(10) Pub. No.: US 2026/0127839 A1
(43) Pub. Date: May 7, 2026

(54) METHOD AND APPARATUS FOR RENDERING HYBRID MEDIA BY COMBINING HETEROGENEOUS MEDIA FOR SPATIAL VIDEO REPRODUCTION SERVICE

(71) Applicant: Electronics and Telecommunications Research Institute, Daejeon (KR)

(72) Inventors: Hong Chang SHIN, Daejeon (KR); Sang Woon KWAK, Daejeon (KR); Gwang Soon LEE, Daejeon (KR)

(73) Assignee: Electronics and Telecommunications Research Institute, Daejeon (KR)

(21) Appl. No.: 19/382,483

(22) Filed: Nov. 7, 2025

(30) Foreign Application Priority Data
Aug. 12, 2025 (KR) 10-2025-0111251
Nov. 7, 2024 (KR) 10-2024-0157043

(51) Int. Cl. G06T 19/20; G06F 3/01; G06T 9/00

(52) U.S. Cl. CPC G06T 19/20; G06F 3/013; G06T 9/00; G06T 9/002; G06F 3/012; G06T 2200/24

(57) ABSTRACT

A method and apparatus for rendering hybrid media by combining heterogeneous media for spatial video reproduction service. An aspect of the present disclosure provides a apparatus for rendering hybrid media by combining heterogeneous media for spatial video reproduction service, the apparatus including a bitstream receiver configured to receive a bitstream containing multiple target attribute data items from a communication network, a target scene acquisition unit configured to obtain multiple target scene data items from the multiple target attribute data items, a selection information acquisition unit configured to obtain a user’s selection information from a user, an input data selection unit configured to select one or more target scene data items based on the user’s selection information from among the multiple target scene data items, and a scene reproduction unit configured to reproduce the one or more target scene data items.

### CROSS-REFERENCE TO RELATED APPLICATION

The present application claims priority to Korean Patent Application No. 10-2024-0157043, filed on November 7, 2024, and Korean Patent Application No. 10-2025-0111251, filed on August 12, 2025, the disclosures of which are incorporated by reference herein in their entireties.

### TECHNICAL FIELD

The present disclosure relates to a method and apparatus for rendering hybrid media by combining heterogeneous media for spatial video reproduction service.

### BACKGROUND

The statements in this section merely provide background information related to the present disclosure and do not necessarily constitute prior art.

Immersive media is a media service that enhances user immersion on various large displays, such as diverse virtual reality (VR) devices like head-mounted displays (HMDs) or a single television or a multiple TV setup.

From the perspective of immersive video, providing full six Degrees of Freedom (6 DoF) for the user's unrestricted motions is considered a fundamental requirement for delivering complete immersion, and related technologies are being developed.

The Moving Picture Expert Group (MPEG), under the International Organization for Standardization/International Electrotechnical Commission (ISO/IEC), is standardizing MPEG Immersive Video (MIV) technology—a multi-viewpoint immersive content compression method for providing 6DoF-supported immersive media services—,Visual Volumetric Video Coding (V3C), a method of efficiently storing and transmitting compressed data, and Gaussian Splat Coding(GSC), a method of compression for compressing and representing 3D Gaussian primitives for real-time rendering of immersive scenes.

V3C is designed to enable the storage and transmission of not only content compressed by using MIV, but also content compressed by using other standard technologies such as Video-based Point Cloud Compression (V-PCC) for high-density point cloud objects.

By using the V3C standard technology and compression standard technologies like MIV, V-PCC, or GSC, corresponding media services can be provided. In such cases, heterogeneous media services may be simultaneously delivered to real or virtual spatial media.

Here, ‘heterogeneous’ may refer to cases where the underlying technologies for providing immersive media services differ, or where the same underlying technology is provided via different media or in different forms depending on the media service scenario.

When such heterogeneous immersive media services are provided simultaneously to the real or virtual spatial media and interact with each other, efficient and seamless media service delivery needs to be ensured, taking these interactions need to be taken into account.

### SUMMARY

According to at least one aspect, the present disclosure provides an apparatus for hybrid reproduction, the apparatus including a bitstream receiver, a target scene acquisition unit, a selection information acquisition unit, an input data selection unit, and a scene reproduction unit. The bitstream receiver is configured to receive a bitstream containing multiple target attribute data items from a communication network. The target scene acquisition unit is configured to obtain multiple target scene data items from the multiple target attribute data items. The selection information acquisition unit is configured to obtain a user’s selection information from a user. The input data selection unit is configured to select one or more target scene data items based on the user’s selection information from among the multiple target scene data items. The scene reproduction unit is configured to reproduce the one or more target scene data items.

According to another aspect, the present disclosure provides a method of performing a hybrid reproduction, including receiving a bitstream containing multiple target attribute data items from a communication network, obtaining multiple target scene data items from the multiple target attribute data items, obtaining a user’s selection information from a user, performing an input data selection by selecting one or more target scene data items based on the user’s selection information from among the multiple target scene data items, and performing a scene reproduction by reproducing the one or more target scene data items.

### BRIEF DESCRIPTION OF THE DRAWINGS

FIG. 1 is a functional block diagram illustrating a hybrid reproduction apparatus according to at least one embodiment of the present disclosure.

FIG. 2 is a diagram illustrating a user experiencing a metaverse or immersive virtual reality (VR) service.

FIG. 3 is a diagram illustrating the global reproduction space divided into a plurality of local unit spaces.

FIG. 4 is a flowchart of a hybrid reproduction method according to at least one embodiment of the present disclosure.

FIG. 5 is a schematic block diagram of an illustrative configuration of a computing device that may be used to implement the methods or apparatuses according to the present disclosure.

### DETAILED DESCRIPTION

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present disclosure and is not intended to represent the only embodiments in which the present disclosure may be practiced.

The present disclosure is directed to providing a method and apparatus for rendering hybrid media by combining heterogeneous media for spatial video reproduction service.

The objects of the present disclosure are not limited to those particularly described hereinabove, and the above and other objects that the present disclosure can achieve will be clearly understood by those skilled in the art from the following detailed description.

Hereinafter, some exemplary embodiments of the present disclosure will be described in detail with reference to the accompanying drawings. In the following description, like reference numerals preferably designate like elements, although the elements are shown in different drawings. Further, in the following description of some embodiments, a detailed description of known functions and configurations incorporated therein will be omitted for the purpose of clarity and for brevity.

Additionally, various terms such as first, second, A, B, (a), (b), etc., are used solely to differentiate one component from the other but not to imply or suggest the substances, order, or sequence of the components. Throughout this specification, when a part ‘includes’ or ‘comprises’ a component, the part is meant to further include other components, not to exclude thereof unless specifically stated to the contrary. The terms such as ‘unit’, ‘module’, and the like refer to one or more units for processing at least one function or operation, which may be implemented by hardware, software, or a combination thereof.

The following detailed description, together with the accompanying drawings, is intended to describe exemplary embodiments of the present invention, and is not intended to represent the only embodiments in which the present invention may be practiced.

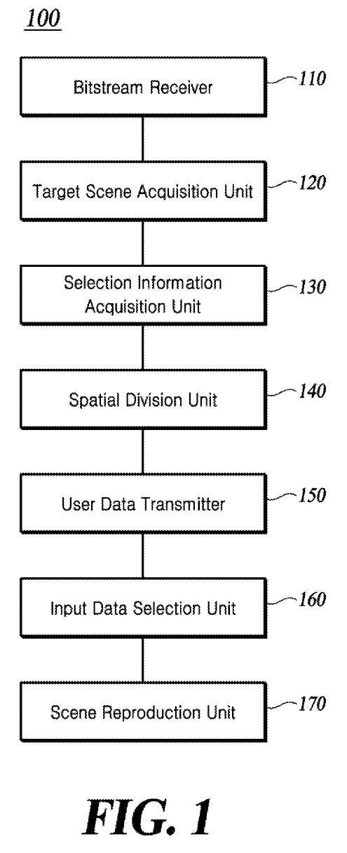

FIG. 1 is a functional block diagram illustrating a hybrid reproduction apparatus 100 according to at least one embodiment of the present disclosure.

The hybrid reproduction apparatus 100 according to at least one embodiment of the present disclosure may be implemented to include a bitstream receiver 110, a target scene acquisition unit 120, a selection information acquisition unit 130, a spatial division unit 140, a user data transmitter 150, an input data selection unit 160, and a scene reproduction unit 170. The hybrid reproduction apparatus 100 according to this embodiment may be implemented by omitting some components from those shown in FIG. 1 or by adding other components not shown in FIG. 1.

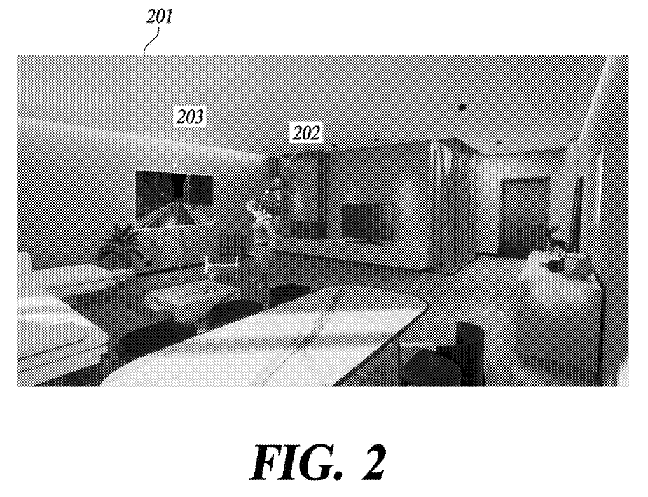

FIG. 2 is a diagram illustrating a user experiencing a metaverse or immersive virtual reality (VR) service.

As shown in FIG. 2, a virtual user or avatar 202 may exist within a first virtual space 201 generated by computer graphics (CG), and a situation is illustrated in which a second virtual space 203 is reproduced within the first virtual space 201.

Here, the first virtual space 201 and the second virtual space 203 may be reproduced by heterogeneous media services. For example, they may be virtual space content reproduced by applying international standard technologies, such as MIV, PCC, Geometry-based Point Cloud Compression (G-PCC), or GSC, which take account of immersive media services.

Here, ‘heterogeneous’ means cases where media technologies based on different underlying technologies are mixed.

For example, the CG-generated background in the first virtual space 201 is a virtual world created by using a 3D graphics engine such as Unreal or Unity. This media primarily relies on computer graphics rendering technology to realistically reproduce the target space.

On the other hand, the second virtual space 203 is a video-based media service reproduced within a portion of the first virtual space 201, where video footage is played back after being produced by using live-action content or CG. This generally relies on video processing technology.

The hybrid reproduction apparatus 100 according to this embodiment is capable of providing a function to implement the second virtual space 203.

The bitstream receiver 110 receives a bitstream containing multiple target attribute data items from a communication network.

The following description assumes that the multiple target attribute data items are multiple encoded data items.

For the second virtual space 203, while playback of an ordinary two-dimensional video may involve loading and playing a file stored in an internal storage device, it may also be provided by using broadcast network-based TV or IP network-based Video On Demand (VOD).

The bitstream receiver 110 receives a bitstream that contains multiple encoded data items necessary for playing back video by using VOD from the communication network.

Here, the multiple encoded data items collectively refer to the respective encoded data items corresponding to a plurality of local unit spaces. This occurs when the global target reproduction space for playing back the target media is divided into the plurality of local unit spaces based on a certain criterion.

Furthermore, the multiple encoded data items collectively refer to the respective encoded data items corresponding to multiple temporal positions when the time axis for reproducing the target media is divided into the multiple temporal positions.

Furthermore, the multiple encoded data items collectively refer to the respective encoded data items corresponding to multiple scales when the scale for reproducing the target media includes the multiple scales.

The target scene acquisition unit 120 obtains multiple target scene data items from the multiple target attribute data items received by the bitstream receiver 110. When the multiple target attribute data items are encoded data items, respectively, the target scene acquisition unit 120 decodes each of the multiple encoded data items received by the bitstream receiver 110 to generate multiple decoded data items as the multiple target scene data items.

The target scene acquisition unit 120 decodes video data among the received encoded data items, for example, by using a video codec.

When the video data (i.e., target video data) is encoded by using a codec other than a video codec, the target scene acquisition unit 120 decodes it by using a codec appropriate to the target data. Example encoding methods for video data other than video codecs include entropy coding methods or encoding methods for artificial neural networks.

The selection information acquisition unit 130 obtains the user's selection information based on the user's motions during the image reproduction process.

Here, the user may be an actual person existing in the real world, or may be a user existing as an avatar within a virtual space, i.e., the space within the images under reproduction.

Furthermore, the user's selection information includes various motions such as the user's spatial relocating action, the user's gaze shifting action, the user's temporal relocating action, the user's predefined action for scale designation, and predefined actions for other reproduction effects of the image.

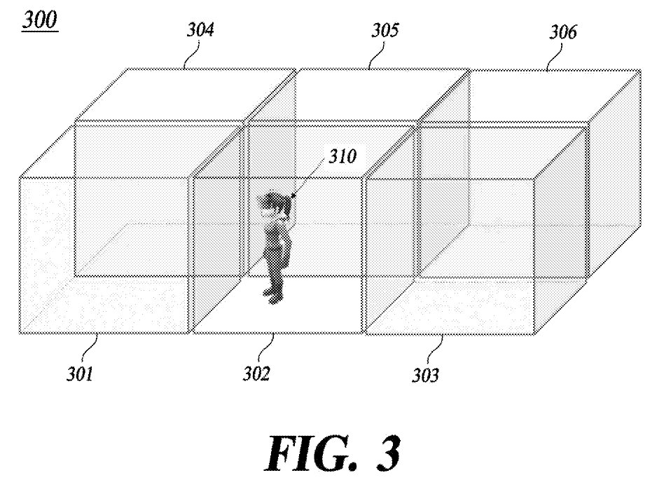

FIG. 3 is a diagram illustrating the global reproduction space divided into a plurality of local unit spaces.

The spatial division unit 140 divides the global reproduction space 300 used to reproduce multiple decoded data items, into a plurality of local unit spaces 301, 302, 303, 304, 305, and 306 based on a predetermined criterion.

Here, the predetermined criterion may be a predetermined size expressed as the horizontal length, vertical length, and height of a space.

The user data transmitter 150 transmits status information containing the current user's (310) location data to a server (not shown). The server is adapted to transmit multiple target attribute data items corresponding to the current user's (310) location data (i.e., the status information) to the bitstream receiver 110 via the communication network.

Here, the multiple target attribute data items may refer to a bitstream containing multiple encoded data items, i.e., multiple spatial attribute data items, corresponding respectively to the plurality of local unit spaces 301, 302, 303, 304, 305, and 306.

The input data selection unit 160 selects one or more decoded data items from the multiple decoded data items.

The input data selection unit 160 may use as a basis the user's selection information obtained by the selection information acquisition unit 130 to select the corresponding one or more decoded data items from among the multiple decoded data items.

The input data selection unit 160 selects one or more local unit spaces based on the user's (310) selection information, among the multiple divided local unit spaces 301, 302, 303, 304, 305, and 306.

The multiple decoded data items may each include decoded data corresponding to each of the plurality of local unit spaces 301, 302, 303, 304, 305, and 306.

In this case, the input data selection unit 160 selects one or more decoded data items based on the user's (310) selection information, among the multiple decoded data items corresponding respectively to the plurality of local unit spaces 301, 302, 303, 304, 305, and 306.

The input data selection unit 160 may determine one or more decoded data items corresponding respectively to the one or more local unit spaces, e.g., the first local unit space 301, etc., selected according to the user's (310) selection information.

For example, in media services reproducing large spaces such as sports stadiums or exhibition halls, the amount of all data required to reproduce the entire area may become too large to transmit.

Therefore, as shown in FIG. 3, when the spatial division unit 140 divides the global area 300 into the plurality of predetermined local unit spaces 301, 302, 303, 304, 305, and 306, multiple target attribute data items for multiple target scene data items, i.e., multiple local scene data items can be transmitted from the server (not shown). In other words, the multiple local scene data items correspond respectively to multiple decoded data items.

If the user 310 is located in the second local unit space 302, all that is needed at the current time is the corresponding encoded data item which is the target scene data (i.e., target attribute data) necessary to represent the scene corresponding to the second local unit space 302.

There is a case where user 310 moves to the first local unit space 301, which is adjacent to the second local unit space 302, when it is desired to receive from the server a bitstream that contains the target attribute data corresponding to the first local unit space 301, and to use the bitstream to decode and reproduce the video. Then, a significant latency may occur from the moment the user's 310 motion begins until the moment the video is reproduced, potentially causing interruptions in the spatial media service.

To tackle such interruptions according to this embodiment, the server may pre-transmit data from one or more local unit spaces adjacent to the target spatial area (i.e., second local unit space 302) of the user 202, 310 at the current point in time along the spatial axis, to the user’ (310) receiving terminal, i.e., the hybrid reproduction apparatus 100.

At this time, the hybrid reproduction apparatus 100 uses spatial attribute data corresponding to the local unit space where the user 202, 310 is currently located (i.e., the second local unit space 302) to start to generate and reproduce the video. When obtaining the user's selection information by the selection information acquisition unit 130, the input data selection unit 160 may select the decoded data corresponding to the selection information [i.e., the decoded data associated with the local unit space (i.e., the first local unit space 301) adjacent to the user’s (202, 310) location] to ensure seamless reproduction of the target video.

The selection information acquisition unit 130 may obtain the user's (202, 310) gaze information as the selection information. Gaze information may refer to the direction being looked at by the user 202, 310 wearing the receiving terminal, meaning the facial direction of the user. Here, the facial direction of the user 202, 310 may be obtained by a direction detector (not shown) mounted on the receiving terminal worn by the user 202, 310.

The input data selection unit 160 may select a single decoded data item corresponding to the gaze information, among the obtained multiple decoded data items of the user 202, 310.

The multiple decoded data items may include decoded data items corresponding respectively to multiple time axes. Namely, each decoded data item among the multiple decoded data items may be data corresponding to a specific temporal position.

For example, the first decoded data item may be data corresponding to 12:00 on March 1, 2025, and the second decoded data item may be data corresponding to 13:10 on March 1, 2025.

Thus, the multiple decoded data items may include decoded data starting from a first past frame located at a specific past point in time relative to the current frame on the time axis, decoded data starting from a first future frame located at a specific future point in time relative to the current frame, and so forth. In this case, each encoded data item included in the bitstream may correspond to data for a single frame, and these individual encoded data items may be combined and transmitted as a single bitstream from the server to the bitstream receiver 110.

If the user's selection information obtained by the selection information acquisition unit 130 corresponds to a temporal relocating action (i.e., a predefined action for time selection), the input data selection unit 160 selects a single decoded data item corresponding to the user's (202, 310) selection information from among the multiple decoded data items corresponding respectively to the multiple time axes.

The multiple decoded data items may include decoded data items corresponding respectively to multiple scales. Namely, each of the multiple decoded data items may be data corresponding to a specific scale.

For example, the first decoded data may be decoded data at a 1/10 scale, and the second decoded data may be decoded data at a 1/100 scale.

Thus, the multiple decoded data items may be divided by a scale hierarchy, wherein each decoded data may be data of a layer corresponding to a specific scale.

If the user's selection information obtained by the selection information acquisition unit 130 corresponds to the user's scale setting action (i.e., a predefined action for scale selection), the input data selection unit 160 selects a single decoded data item corresponding to the user's (202, 310) selection information from among the multiple decoded data items corresponding respectively to the multiple scales.

The target attribute data required for scene reproduction in the respective local unit spaces 301, 302, 303, 304, 305, and 306 may be obtained by images from multiple viewpoints obtained simultaneously through a multi-view camera system, etc., and viewpoint images at multiple locations may be obtained by moving a single camera.

In this case, multiple target attribute data items may be obtained by using the geometric relationship information of all viewpoint images through a camera calibration process applied to the obtained multiple viewpoint images.

In this case, the more viewpoint image data captured of the target space, the higher the quality and resolution of the reproducible scene. However, if the video data becomes too large, storage capacity and the amount of data requiring real-time processing increase. Therefore, encoding/decoding or codec technology is typically used to provide high-quality, high-resolution media services by using minimal data.

Thus, when codec technology is used, the bitstream received by the bitstream receiver 110 includes encoded data as target attribute data (or scale attribute data, temporal position attribute data, etc.). The target scene acquisition unit 120 decodes the encoded data included in the bitstream to generate decoded data and determines the generated decoded data as target scene data.

Examples of codec technologies include MPEG Immersive Video (MIV) that is an international standard technology considering immersive media services, and Point Cloud Compression (PCC) or Geometry-based Point Cloud Compression (G-PCC) for 3D point cloud-based media services; and Gaussian Splat Coding (GSC) for compressing and representing 3D Gaussian primitives used in real-time immersive rendering.

Furthermore, example codec technologies include general 2D video compression standard technologies such as Advanced Video Coding (AVC), High Efficiency Video Codec (HEVC), and Versatile Video Coding (VVC), and entropy coding technology widely used as a lossless compression technique to reduce information volume.

The target attribute data is transmitted to the user's (310) receiving terminal in a form encoded by the aforementioned codec technologies, and undergoes a process where the target scene acquisition unit 120 decodes the target attribute data.

The scene reproduction unit 170 performs a preprocessing step (e.g., secondary decoding) on the decoded data according to the information on the decoded data to generate the target image by using the selected decoded data. Here, the preprocessing step may vary depending on the codec technologies used to generate the encoded data and decoded data in this embodiment.

For example, when the decoded data includes data coded by using codec techniques such as MIV, PCC,V-PCC, G-PCC, or GSC the scene reproduction unit 170 performs a secondary decoding process on the decoded data to reproduce the video for the decoded data. In other words, the scene reproduction unit 170 performs MIV decoding if the decoded data contains MIV-encoded data, performs PCC decoding if it contains PCC-encoded data, performs V-PCC decoding if it contains V-PCC-encoded data, performs G-PCC decoding if it contains G-PCC-encoded data, and performs GSC decoding if it contains GSC-encoded data.

In yet another embodiment, the decoded data may include data processed by using artificial neural network-based codec techniques. For example, representative techniques primarily used for virtual viewpoint synthesis or spatial reconstruction include Neural Radiance Field (NeRF) and 3D Gaussian Splatting (3D GS) technologies.

The NeRF technique involves inputting a feature vector containing target coordinate information into a neural network structure, such as a Multi-Layer Perceptron (MLP), to represent the target scene. Then, through an inference process, attribute information to be used in the scene representation at the target location is outputted. By using this outputted attribute information, a video at the target viewpoint may be generated.

Unlike NeRF, 3D GS technology is an explicit representation approach. During the pre-training phase, it pre-learns attribute information items to be used for representing the target space and subsequently transmits this learned attribute information. More specifically, fundamentally required attributes corresponding to Gaussian information located in the target space includes spherical harmonics coefficients, rotation information, position information (translation), scaling information, and opacity information.

This information items may be encoded in a video format for transmission, or they may undergo entropy coding before transmission. Some information items may also be learned by using a neural network structure such as an MLP and transmitted in the form of a learned network-type matrix data format.

In this case, a process is needed to first decode or convert the information items into the basic data formats used in the fundamental rendering techniques of 3D GS, such as spherical harmonics coefficients, rotation information, position information (translation), scaling information, and opacity information. This preprocessing is performed within the scene reproduction unit 170.

Furthermore, the scene reproduction unit 170 may also perform the process of decoding the transmitted metadata for use in the secondary decoding process.

Upon completing the preprocessing step that includes secondary decoding, the scene reproduction unit 170 synthesizes the viewport images at the target image position by using the attribute information items derived from the secondary decoding. Here, the target image position may be determined based on user motion information.

The scene reproduction unit 170 performs the process of reproducing the viewport image (i.e., the target image) generated in the preceding process.

When the hybrid reproduction apparatus 100 is implemented on a general display device such as a TV or monitor, high-speed reproduction technology is needed to reproduce the viewport images in real time on the general display device. For this purpose, the scene reproduction unit 170 subsequently performs a high-speed rendering process through a graphics pipeline process such as DirectX or OpenGL.

Furthermore, when the hybrid reproduction apparatus 100 is implemented on a special display device such as an HMD, to reproduce the viewport images on the HMD, the scene reproduction unit 170 performs a process of adjusting the size of the viewport image to match the input specifications required by the HMD.

For example, in such an environment as shown in FIG. 2, to reproduce the viewport images in the second virtual space 203, a process may be performed for coordinate conversion of the viewport image into the reference coordinate system of the virtual space corresponding to the display size of the HMD.

In yet another embodiment, the hybrid reproduction apparatus 100 may be implemented in a glassless multi-view display device.

When the hybrid reproduction apparatus 100 is implemented as a glassless multi-view display, simultaneously reproducing at least two, up to several tens, or even over a hundred viewpoint images enable viewing of three-dimensional images. This is achieved by providing motion parallax through a lenticular lens mounted in front of the display.

To reproduce multiple viewpoint images on such a glassless multi-viewpoint display, the scene reproduction unit 170 may perform a view multiplexing preprocessing step.

To enable real-time operation of all functions of the bitstream receiver 110, target scene acquisition unit 120, spatial division unit 140, input data selection unit 160, and scene reproduction unit 170 within the hybrid reproduction apparatus 100, the latter is implemented as a high-speed computational processing device capable of handling large-volume data.

A representative example of such a high-speed computation processing device is a Graphics Processing Unit (GPU). Since NeRF or 3DGS requires computation processing based on artificial neural networks, the high-speed computation processing device may be implemented as an AI accelerator, Neural Processing Unit (NPU), Tensor Processing Unit (TPU), AI chip, etc.

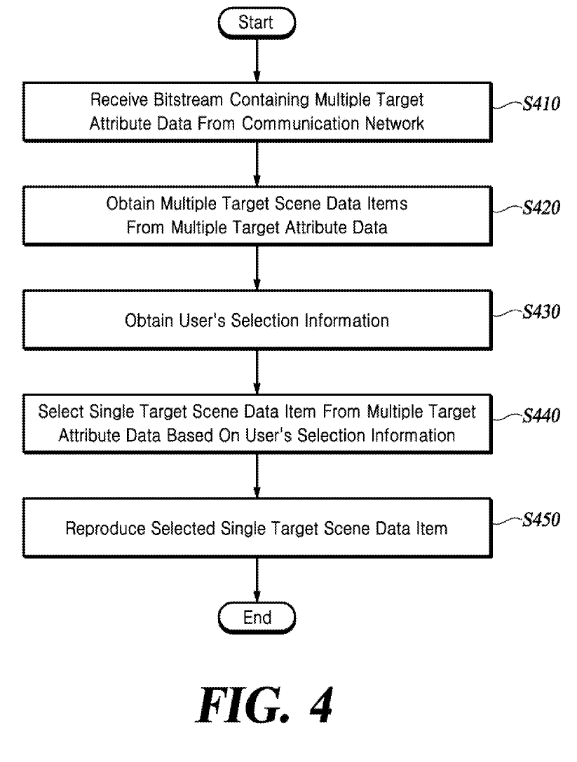

FIG. 4 is a flowchart of a hybrid reproduction method according to at least one embodiment of the present disclosure.

The hybrid reproduction method according to this embodiment is performed by the hybrid reproduction apparatus 100.

The bitstream receiver 110 performs a bitstream reception process to receive a bitstream containing multiple target attribute data items from a communication network (S410).

The target scene acquisition unit 120 performs a target scene acquisition process to obtain multiple target scene data items from the multiple target attribute data items (S420).

The selection information acquisition unit 130 performs a select information acquisition process to obtain the user's selection information (S430).

The input data selection unit 160 performs a data selection process to select one or more target scene data items based on the user's selection information from the multiple target scene data items (S440).

The scene reproduction unit 170 performs a scene reproduction process to reproduce the selected one or more target scene data items (S450).

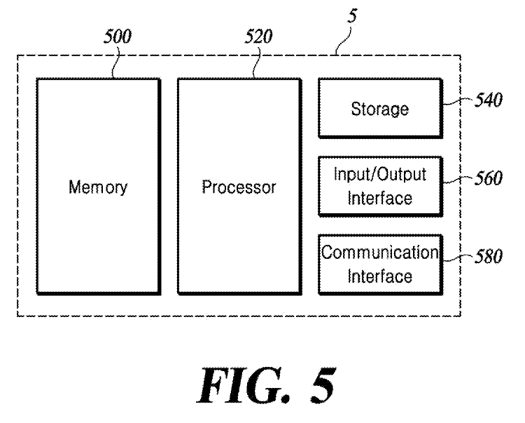

FIG. 5 is a block diagram illustrating an exemplary computing device that may be used for implementing a method or an apparatus according to the present disclosure.

A computing device 5 may be provided with some or all of a memory 500, a processor 520, a storage 540, an input/output interface 560, and a communication interface 580. The computing device 5 may be a stationary computing device, such as a desktop computer, server, etc., as well as a mobile computing device, such as a laptop computer, automotive electronics, etc. The computing device 5 may be implemented as any specialized hardware accelerator capable of efficiently processing computations on the artificial intelligence model. For example, the computing device 5 may include a graphics processing unit (GPU), a tensor processing unit (TPU), or a neural processing unit (NPU).

The memory 500 may store programs that cause the processor 520 to perform methods or operations under various embodiments of the present disclosure. For example, the program may include a plurality of instructions executable by the processor 520, and the plurality of instructions may be executed by the processor 520 to perform the method with the steps illustrated in FIG. 4. The memory 500 may be a single memory or a plurality of memories. In this case, the information required to perform the methods or operations according to various embodiments of the disclosure may be stored in a single memory or stored divisively among the plurality of memories. When the memory 500 is composed of a plurality of memories, they may be physically separated. The memory 500 may include at least one of volatile memory and non-volatile memory. The volatile memory may include static random access memory (SRAM) or dynamic random access memory (DRAM), for example, and the non-volatile memory may include flash memory, for example.

The processor 520 may include at least one core capable of executing at least one set of instructions. The processor 520 may execute instructions stored in the memory 500. The processor 520 may be a single processor or a plurality of processors.

The storage 540 maintains stored data even when power to the computing device 5 is interrupted. For example, the storage 540 may include non-volatile memory or may include a storage medium such as magnetic tape, optical disk, or magnetic disk. Programs stored in the storage 540 may be loaded into the memory 500 before execution by the processor 520. The storage 540 may store files written in a programming language, and programs generated by a compiler or the like may be loaded from the files into the memory 500. The storage 540 may store data to be processed by the processor 520 and/or data that has been processed by the processor 520.

The input/output interface 560 may include an input device, such as a keyboard, mouse, touchscreen, microphone, etc., and an output device, such as a display device, speaker, etc. Through the input/output interface 560, a user can trigger the execution of a program by the processor 520 via the input device and/or view the results of processing by the processor 520.

The communication interface 580 may provide access to an external network. For example, the computing device 5 may communicate with other devices via the communication interface 580.

The components described in the example embodiments may be implemented by hardware components including, for example, at least one digital signal processor (DSP), a processor, a controller, an application-specific integrated circuit (ASIC), a programmable logic element, such as an FPGA, other electronic devices, or combinations thereof. At least some of the functions or the processes described in the example embodiments may be implemented by software, and the software may be recorded on a recording medium. The components, the functions, and the processes described in the example embodiments may be implemented by a combination of hardware and software.

The method according to example embodiments may be embodied as a program that is executable by a computer, and may be implemented as various recording media such as a magnetic storage medium, an optical reading medium, and a digital storage medium.

Various techniques described herein may be implemented as digital electronic circuitry, or as computer hardware, firmware, software, or combinations thereof. The techniques may be implemented as a computer program product, i.e., a computer program tangibly embodied in an information carrier, e.g., in a machine-readable storage device (for example, a computer-readable medium) or in a propagated signal for processing by, or to control an operation of a data processing apparatus, e.g., a programmable processor, a computer, or multiple computers. A computer program(s) may be written in any form of a programming language, including compiled or interpreted languages and may be deployed in any form including a stand-alone program or a module, a component, a subroutine, or other units suitable for use in a computing environment. A computer program may be deployed to be executed on one computer or on multiple computers at one site or distributed across multiple sites and interconnected by a communication network.

Processors suitable for execution of a computer program include, by way of example, both general and special purpose microprocessors, and any one or more processors of any kind of digital computer. Generally, a processor will receive instructions and data from a read-only memory or a random access memory or both. Elements of a computer may include at least one processor to execute instructions and one or more memory devices to store instructions and data. Generally, a computer will also include or be coupled to receive data from, transfer data to, or perform both on one or more mass storage devices to store data, e.g., magnetic, magneto-optical disks, or optical disks. Examples of information carriers suitable for embodying computer program instructions and data include semiconductor memory devices, for example, magnetic media such as a hard disk, a floppy disk, and a magnetic tape, optical media such as a compact disk read only memory (CD-ROM), a digital video disk (DVD), etc. and magneto-optical media such as a floptical disk, and a read only memory (ROM), a random access memory (RAM), a flash memory, an erasable programmable ROM (EPROM), and an electrically erasable programmable ROM (EEPROM) and any other known computer readable medium. A processor and a memory may be supplemented by, or integrated into, a special purpose logic circuit.

The processor may run an operating system (OS) and one or more software applications that run on the OS. The processor device also may access, store, manipulate, process, and create data in response to execution of the software. For purpose of simplicity, the description of a processor device is used as singular; however, one skilled in the art will be appreciated that a processor device may include multiple processing elements and/or multiple types of processing elements. For example, a processor device may include multiple processors or a processor and a controller. In addition, different processing configurations are possible, such as parallel processors.

Also, non-transitory computer-readable media may be any available media that may be accessed by a computer, and may include both computer storage media and transmission media.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

As described above, according to the embodiments, when heterogeneous immersive media services are provided in combination by using general or specialized display devices and there is interaction between heterogeneous immersive media services, the present disclosure can provide efficient reproduction of the hybrid media.

The effects of the present disclosure are not limited to those mentioned above, and other effects not mentioned will be apparent to those of ordinary skill in the art from the above description.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. An apparatus for hybrid reproduction, the apparatus comprising:
at least one memory storing commands; and
at least one processor,
wherein, by executing the commands, the at least one processor is to:
a bitstream receiver configured to receive a bitstream containing multiple target attribute data items from a communication network;
a target scene acquisition unit configured to obtain multiple target scene data items from the multiple target attribute data items;
a selection information acquisition unit configured to obtain a user’s selection information from a user;
an input data selection unit configured to select one or more target scene data items based on the user’s selection information from among the multiple target scene data items; and
a scene reproduction unit configured to reproduce the one or more target scene data items.

2. The apparatus of claim 1, further comprising:
a spatial division unit configured to divide, based on a predetermined criterion, a global reproduction space for reproducing the multiple target scene data items into a plurality of local unit spaces,
wherein the multiple target scene data items correspond to the plurality of local unit spaces, respectively.

3. The apparatus of claim 2, wherein the input data selection unit is configured
to select one or more local unit spaces based on the user's selection information from among the multiple target scene data items corresponding respectively to the plurality of local unit spaces, and
to select the one or more target scene data items corresponding respectively to the one or more local unit spaces.

4. The apparatus of claim 1, wherein the selection information acquisition unit is configured to obtain a gaze of the user as the user’s selection information, and
wherein the input data selection unit is configured to select the one or more target scene data items based on the gaze.

5. The apparatus of claim 1, wherein the multiple target scene data items comprise:
multiple target scene data items that correspond respectively to multiple time axes, and
wherein the input data selection unit is configured to select the one or more target scene data items based on the user’s selection information from among the multiple target scene data items corresponding respectively to the multiple time axes.

6. The apparatus of claim 1, wherein the multiple target scene data items comprise:
multiple target scene data items that correspond respectively to multiple scales, and
wherein the input data selection unit is configured to select the one or more target scene data items based on the user’s selection information from among the multiple target scene data items corresponding respectively to the multiple scales.

7. The apparatus of claim 1, wherein the multiple target attribute data items include respective encoded data items, and
wherein the target scene acquisition unit is configured to decode the respective encoded data items to generate multiple decoded data items, and to learn the multiple decoded data items as the multiple target scene data items.

8. A method of performing a hybrid reproduction, the method comprising:
receiving a bitstream containing multiple target attribute data items from a communication network;
obtaining multiple target scene data items from the multiple target attribute data items;
obtaining a user’s selection information from a user;
performing an input data selection by selecting one or more target scene data items based on the user’s selection information from among the multiple target scene data items; and
performing a scene reproduction by reproducing the one or more target scene data items.

9. The method of claim 8, further comprising:
performing a spatial division by dividing, based on a predetermined criterion, a global reproduction space for reproducing the multiple target scene data items into a plurality of local unit spaces,
wherein the multiple target scene data items correspond to the plurality of local unit spaces, respectively.

10. The method of claim 9, wherein the performing of the input data selection comprises:
selecting one or more local unit spaces based on the user's selection information from among the multiple target scene data items corresponding respectively to the plurality of local unit spaces; and
selecting the one or more target scene data items corresponding respectively to the one or more local unit spaces.

11. The method of claim 8, wherein the obtaining of the selection information comprises:
obtaining a gaze of the user as the user’s selection information; and
wherein the selecting input data comprises
selecting the one or more target scene data items based on the gaze.

12. The method of claim 8, wherein the multiple target scene data items comprise:
multiple target scene data items that correspond respectively to multiple time axes, and
wherein the performing of the input data selection comprises selecting the one or more target scene data items based on the user’s selection information from among the multiple target scene data items corresponding respectively to the multiple time axes.

13. The method of claim 8, wherein the multiple target scene data items comprise:
multiple target scene data items that correspond respectively to multiple scales, and
wherein the performing of the input data selection comprises selecting the one or more target scene data items based on the user’s selection information from among the multiple target scene data items corresponding respectively to the multiple scales.
